(19) United States
(12) Patent Application Publication
(10) Pub. No.: US 2008/0052888 A1
(43) Pub. Date: Mar. 6, 2008

(54) Method and device for fabricating a toothing at a three-dimensional body produced by forming and fine blanking

(76) Inventor: Paul Frauchiger, Cincinnati, OH (US)

Correspondence Address: JORDAN AND HAMBURG LLP, 122 EAST 42ND STREET, SUITE 4000, NEW YORK, NY, 10168, US

(21) Appl. No.: 11/591,372

(22) Filed: Oct. 31, 2006

(30) Foreign Application Priority Data
Sep. 1, 2006 (EP) 06090152.7

(51) Int. Cl. B23P 23/04

(52) U.S. Cl. 29/33 R

(57) ABSTRACT

The invention relates to a method and a tool for fabricating a toothing at a three-dimensional body produced by forming and fine blanking, especially an attachment for car seat components or the like produced out of a flat strip, wherein the flat strip by forming and fine blanking in a tool is formed into a pot-shaped body with placed in the base of the body inner forms like impressions and/or projections and/or indentations and/or recesses and/or sinks and/or holes and/or pivots and a substantially evenly curved edge and afterwards into the edge is fabricated a toothing radially extending to the inner side of the body.

The invention has the object to improve a method and a device for the fabrication of a toothing at a pot-shaped body produced by forming and fine blanking in a way, that the fine blanking of toothings is economically applicable also in case of dynamically balanced three-dimensional bodies such as hinge attachments with simultaneously increasing dimensional accuracy of the toothing, wherein the process safety increases because of the cessation of the heat treatment and the tool can be designed more compact.

This object is solved by that the toothing in the edge of the pot-shaped body is exclusively produced by cutting or shaving with a fine blanking die or a shaving device and wherein a burr or shaving chips developing during cutting or shaving is pressed into a recess in the base of the pot-shaped body allocated to the toothing.

The invention relates to a method for fabricating a toothing at a three-dimensional body produced by forming and fine blanking, especially an attachment for car seat components or the like produced out of a flat strip, wherein the flat strip by forming and fine blanking in a tool is formed into a pot-shaped body with placed in the base of the body inner forms like impressions and/or projections and/or indentations and/or recesses and/or sinks and/or holes and/or pivots and a substantially evenly curved edge and afterwards into the edge is fabricated a toothing radially extending to the inner side of the body.

The invention further relates to a device for the fabrication of a toothing at a three-dimensional pot-shaped body produced by forming and fine blanking, especially a hinge attachment for car seat components or the like, with a tool for forming teeth into a substantially evenly curved edge of a pot-shaped body having inner forms in its base such as impressions and/or projections and/or indentations and/or recesses and/or sinks and/or holes and/or pivots, wherein the teeth of the toothing radially extend to the inner side of the pot-shaped body, in which the three-dimensional body is fixed between a base plate and a pressure pad.

### STATE OF THE ART

Seat adjustment components, for example fix and swivelling hinge parts of hinge attachments, as known are produced by forming, fine blanking or stamping with the necessary for their final use high dimensional accuracy. These hinge parts for transmitting rotational movements have inner or outer toothings, which are formed as projections in one piece with the respective hinge part (DE 32 44 399 C2, DE 28 34 492 C2, DE 32 27 222 C1).

It is common to produce toothings at hinge attachments by fine blanking (DE 32 44 399 C2, DE 198 01 431 A1). These known hinge attachments are all consist of disk-shaped attachment parts. But as soon as hinge attachments have a dynamically balanced, i.e. three-dimensional, form of their body up to now toothings can not be economically produced by common fine blanking, because the burr developing during fine blanking can not be removed even by a downstream second process step due to the three-dimensional transitions in the region of the fine blanking surface. That is why inner toothings at three-dimensional hinge attachments are produced by cold forming (see for example DE 197 50 184 A1), what however is connected with the disadvantage of reduced dimensional accuracy of the teeth, because the tips of the teeth are always rounded. Furthermore, cold forming is connected with the disadvantage, that an additional heat treatment as for example interstage annealing of the cold formed toothing becomes necessary, what leads to a loss of time and higher production costs.

### OBJECT

At this state of the art the invention has the object to improve a method and a device for the fabrication of a toothing at a pot-shaped body produced by forming and fine blanking in a way, that the fine blanking of toothings is economically applicable also in case of dynamically balanced three-dimensional bodies such as hinge attachments with simultaneously increasing dimensional accuracy of the toothing, wherein the process safety is increased because of the cessation of the heat treatment and the tool can be designed more compact.

This object is solved by a method of the kind discussed above with the characterizing features of claim 1 and by a device with the characterizing features of claim 5.

Advantageous aspects of the method and the tool can be learned from the dependent claims.

The solution according to this invention stands out for, that toothings, for example inner toothings at three-dimensional dynamically balanced bodies, can be produced by fine blanking or shaving with higher dimensional accuracy and economic efficiency.

Of special importance is, that it becomes possible to create a 100% even cut surface without a further process step, because the burr or shaving chips developing during cutting or shaving is pressed into a recess in the base of the pot-shaped body allocated to the toothing.

The teeth of the toothing are filled with material up to their tips, whereby the dimensional accuracy is substantially improved.

The cessation of the heat treatment besides the effect of saving a whole process stage also leads to the extraordinary advantage, that sources of errors in the execution of the process are eliminated and thus the process safety is improved.

The device according to this invention can be integrated into the production process of hinge attachments by fine blanking and stamping as well as forming operations. Because it becomes possible to produce the inner toothing by fine blanking and shaving operations, the tool can be designed more compact.

Further advantages and details can be learned from the following description with reference to the enclosed drawings.

### EMBODIMENT

In the following the invention shall be explained more detailed at the example of an embodiment.

### It is shown in

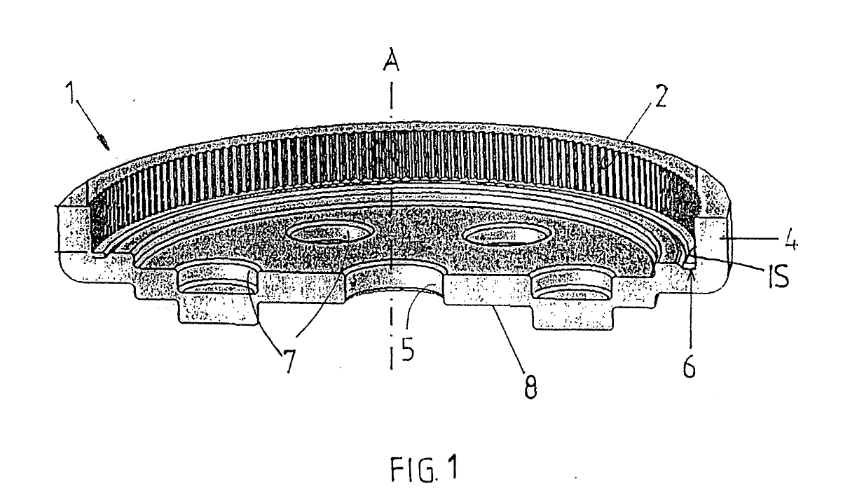

FIG. 1: a sectional view through a common three-dimensional hinge attachment with inner toothing, which was produced according to the method of this invention,

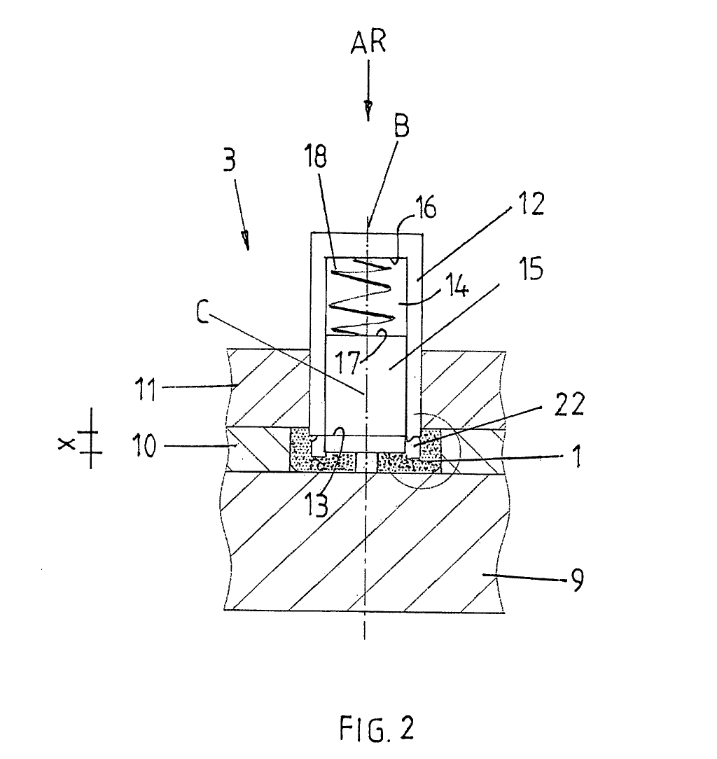

FIG. 2: a principal diagram of the device according to this invention,

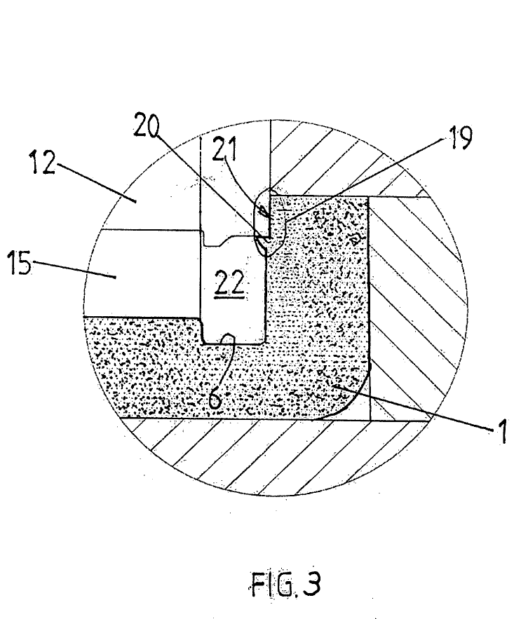

FIG. 3: a schematic diagram of the fine blanking at the beginning of the method according to this invention,

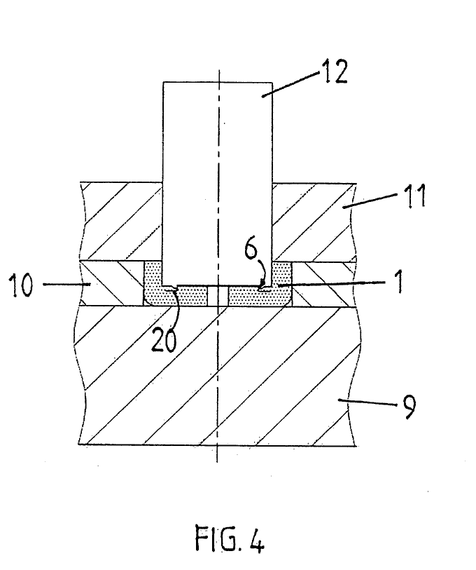

FIG. 4: a schematic diagram of the fine blanking at the end of the method according to this invention.

By means of the method according to this invention shall be produced a three-dimensional pot-shaped body 1 (hinge attachment) with an inner toothing 2.

FIG. 2 shows the principal construction of the device 3 according to this invention by means of which the method according to this invention is executed.

In the finished state the pot-shaped body 1 has a circular edge 4, a central hole 5 for inserting the hinge axle A, a circular embossed recess 6 adjacent to edge 4 and ejected impressions 7 in the base 8 of body 1, which serve for fixing to the frame of the back of the seat, for example by welding.

The device 3 according to this invention—as shown in FIG. 2—has a base plate 9, on which the pot-shaped body 1 is fixed. The pot-shaped body 1 is hold by a distance plate 10 the height of which corresponds to the height of the body 1. On the circular edge 4 of body 1 lies a pressure pad 11, which firmly fixes body 1 between base plate 9 and pressure pad 11.

The fine blanking die 12 is part of a fine blanking tool not shown. The working direction of the fine blanking die 12 is denoted with AR.

In the end portion 13 of the fine blanking die 12, that extends towards body 1, is provided a hollow space 14, in which is placed a sliding pilot die 15, the axis C of which lies on the axis B of the fine blanking die 12. This pilot die 15 by a compression spring 18, which is placed between the bottom end 16 of the hollow space 14 and the end 17 of the pilot die 15, extending to the direction away from body 1, is pushed to a certain amount X out of the hollow space 14.

As soon as the fine blanking die 12 controlled by the pressure pad 11 moves in working direction AR, the fine blanking die 12 starts to cut a toothing 19 at the inner side IS of the circular edge 4 and at its front side shifts a burr 20 on the cutting surface 21 along the inner side IS of the edge 4 (see FIG. 3). The compression spring 18 simultaneously pushes the pilot die 15 to the amount X out of the hollow space 14 of the fine blanking die 12, so that the pilot die 15 contacts the base 8 of body 1 and between the cutting surface 21 on the inner side IS in alignment with indentation 6 creates a groove 22. The burr 20 with the descending movement of the fine blanking die 12 purposefully shifts in this groove 22 downwards into the indentation 6. In the case that in place of a fine blanking die 12 is used a shaving die not shown here, the groove 22 serves for the purposeful diversion or deflection of possibly developing shaving chips into the indentation 6 and simultaneously prevents shaving chips from getting outside through hole 5.

FIG. 4 shows the final position of the fine blanking die 12, in which the fine blanking die 12 has contacted the base 8 and has pressed the burr 20 into the indentation 6. The pilot die 15 in this position is pushed back into the hollow space 14 against the compression spring 18. During the process of creating the toothing in edge 4 of the pot-shaped body 1 is applied an at least two-staged shaving operation, wherein a shaving die forms the toothing 19 at the inner side IS. The developing shaving chips through groove 22 are led into the indentation and pressed into it by the shaving die as soon as the latter contacts the base 8 of the pot-shaped body 1.

### LIST OF DRAWING REFERENCES

pot-shaped body (hinge attachment) 1
inner toothing 2
device 3
edge of 1 4
hole in 1 5
recess in 1 6
impression 7
base of 1 8
base plate of 3 9
distance plate of 3 10
pressure pad of 3 11
fine blanking die 12
end of 12 13
hollow space 14
pilot die 15
bottom end of 14 16
opposite end of 12 17
compression spring 18
toothing 19
burr 20
cutting surface 21
groove 22
axis of 1 A
working direction of 12 AR
axis of 12 B
axis of 15 C
amount to which 15 is pushed out of 14 X
inner side of 4 Is

1-8. (canceled)

9. A method for fabricating a toothing at a three-dimensional body, comprising:
forming and fine blanking a pot-shaped body out of a flat strip in a tool, said pot-shaped body having inner forms in a base thereof and including a substantially evenly curved edge; and
fabricating a toothing in the edge radially extending to an inner side of the body, the toothing in the edge of the pot-shaped body being exclusively produced by cutting and/or shaving with a fine blanking die and/or a shaving device, and a burr and/or shaving chips developing during the cutting and/or shaving being pressed into an indentation allocated to the toothing.

10. A method according to claim 9, wherein said three-dimensional body is an attachment for a car seat.

11. A method according to claim 9, wherein said inner forms include at least one of impressions, projections, indentations, recesses, sinks, holes and pivots.

12. A method according to claim 9, wherein, before the cutting and/or shaving, the base of the pot-shaped body is fixed by advancement of a fine blanking die and/or shaving device pilot die, and the burr and/or the shaving chips are led and pressed into the indentation with defined location as being centrally delimited by the fine blanking die or shaving device pilot die.

13. A method according to claim 9, wherein the shaving is executed as an at least two-staged operation.

14. A method according to claim 9, wherein the fine blanking is executed in combination with the shaving.

15. A device for the fabrication of a toothing at a three-dimensional pot-shaped body produced by forming and fine blanking, comprising:
a tool for forming teeth into a substantially evenly curved edge of a pot-shaped body having inner forms in a base thereof, the teeth of the toothing radially extending to an inner side of the pot-shaped body, the three-dimensional body being fixed between a base plate and a pressure pad, the tool including a die for fine blanking or shaving in which is provided a hollow space;
a sliding pilot die being placed within said hollow space, movable in a working direction of the tool and engageable with the base of the pot-shaped body, said pilot die being biased by a spring and coupled to said die such that the pilot die, during a descending movement thereof, advances the die and a groove is created between the cut or shaved surface of the inner toothing and the pilot die for leading the fine blanking burr or shaving chips into the recess of the body, wherein the die, when reaching a lowest position thereof, fixes and presses the burr or the chips into the recess.

16. A device according to claim 15, wherein said three-dimensional pot-shaped body is an attachment for a car seat.

17. A method according to claim 15, wherein said inner forms include at least one of impressions, projections, indentations, recesses, sinks, holes and pivots.

18. A device according to claim 15, wherein the spring is a compression spring.

19. A device according to claim 15, wherein a distance plate having a height which corresponds to a height of the pot-shaped body is placed between the base plate and pressure pad.

20. A device according to claim 15, wherein the die and the pilot die have a common axis.
